(19) United States
(12) Patent Application Publication
(10) Pub. No.: US 2002/0095842 A1
(43) Pub. Date: Jul. 25, 2002

(54) Display devices

(76) Inventors: Michael A. Wenz, Freeland, MI (US); Mark R. Wenz, Freeland, MI (US)

Correspondence Address: ROBERT L. McKELLAR, 3031 East Lois Avenue, MIDLAND, MI, 48640-8928, US

(21) Appl. No.: 09/767,486

(22) Filed: Jan. 23, 2001

(51) Int. Cl. G09F 15/00

(52) U.S. Cl. 40/610

(57) ABSTRACT

What is disclosed herein are display devices, especially graphic display devices, which are economical to manufacture, are convenient to assemble and disassemble for creating multiple display systems, for example, for creating a tradeshow back wall or background.

### BACKGROUND OF THE INVENTION

The invention disclosed herein deals with display devices, especially graphic display devices, which are economical to manufacture, are convenient to assemble and disassemble, are aesthetically appealing, have convenient and low cost shipping capabilities, have the capability of easy interchange of graphics used therewith, have the capability of creating multiple systems, for example, for creating a tradeshow back wall or background, have no moving parts, are lightweight and compact such that they can be easily stored in a storage bag or case.

Applicants are aware of several commercially available display devices, but none of them have the configuration or utility of the displays of the instant invention.

### THE INVENTION

The invention disclosed and claimed herein deals with display devices, such devices comprising a base to support the display, and display support rods, at least two support rods, an upper holder rod and, a lower holder rod, wherein the base is comprised of two parallel and spaced-apart side rails and at least one connecting rail.

Each side rail has a middle zone, a back end, a front end, an inside surface and a top surface, wherein each side rail has mounted on its top surface, and near the back end, a support rod connector. Also, each side rail has mounted on the top surface and near the front end, a lower holder rod connector.

Each side rail has mounted in the middle zone on the inside surface thereof, a side rail connector for the attachment of a common connector rail for connection to each of the side rails for connecting the two side rails together,

Each support rod connector is capable of and holds a support rod, each support rod has an upper end and each upper end is connected by an upper holder rod connector to the upper holder rod to support the upper holder rod.

In another embodiment of this invention, there is a device in which there is only one support rod for supporting the upper holder rod.

Thus, there is disclosed and claimed a display device comprising a base, a support rod, an upper holder rod and, a lower holder rod, wherein the base is comprised of two parallel and spaced-apart side rails wherein each of the side rails has a middle zone, a back end, a front end, an inside surface and a top surface.

Each side rail has mounted on the top surface and near the front end, a lower holder rod connector and each side rail has mounted in the middle zone on the inside surface, a first side rail connector for the attachment of a first common connector rail for connection to each of the side rails for connecting the two side rails together.

Each side rail has mounted at the respective back ends thereof a second side rail connector for the attachment of a second common connector rail for connection to each of the side rails for connecting the two side rails together, wherein the second common connector rail has a middle zone and a top surface. The second common connector rail has mounted on the top surface, and in the middle zone, a support rod connector.

The support rod connector is capable of and holds a support rod. The support rod has an upper end; the upper end is connected by an upper holder rod connector to the upper holder rod to support the upper holder rod.

### BRIEF DESCRIPTION OF THE DRAWINGS

FIG. 1 is a full front view of a display device of this invention.

FIG. 2 is a side view of the display device of FIG. 1.

FIG. 3 is a full top view of the base of the device of FIG. 1.

FIG. 4 is a full top view of a side rail of the base of FIG. 3.

FIG. 5 is a view of the forward end of a side rail showing the lower holding rod connector.

FIG. 6 is a full front view of the upper holder bar of this invention, showing the connector mechanisms for the support bars of the inventive device.

FIG. 7 is a side view of a portion of the rearward portion of a side rail showing a support rod connector for a support rod of this invention.

FIG. 8 is a view in front perspective of a device of this invention.

FIG. 9 is a full top view of a device of this invention with the support rods under tension.

FIG. 10 is a full front view in perspective of a graphic display device of this invention, with the graphic display piece in place.

FIG. 11 is a full top view of another embodiment of this invention in which only one support rod is used.

FIG. 12 is a front view of a system of this invention using a combination of the display devices of the invention.

### DETAILED DESCRIPTION OF THE INVENTION

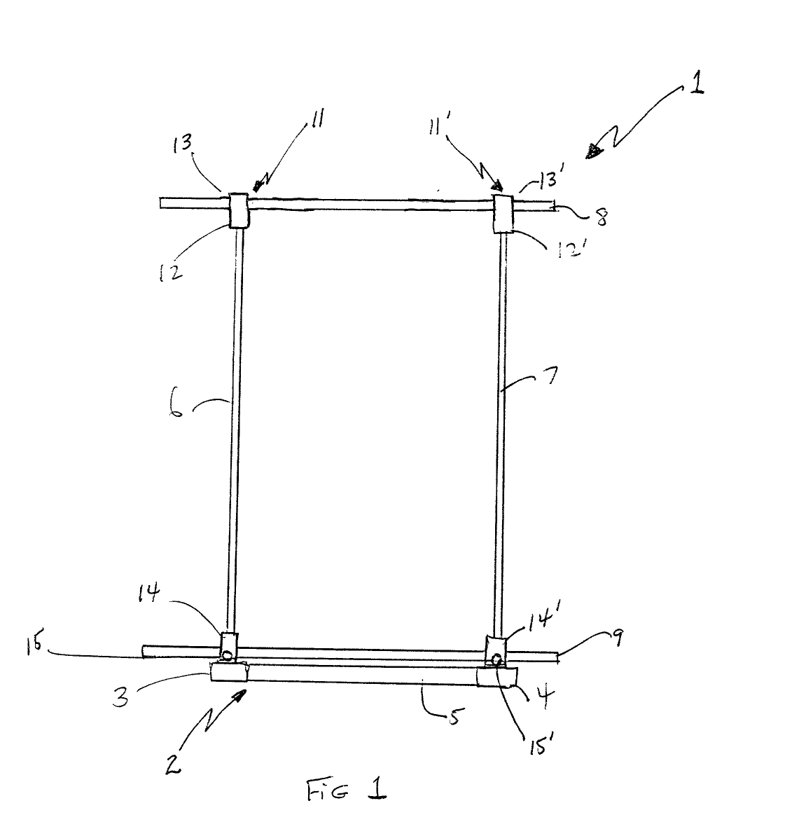

Turning now to FIG. 1, there is shown a full front view of a display device 1 of this invention in which there is shown the base 2, having two parallel, spaced-apart side rails 3 and 4, and a connector rail 5.

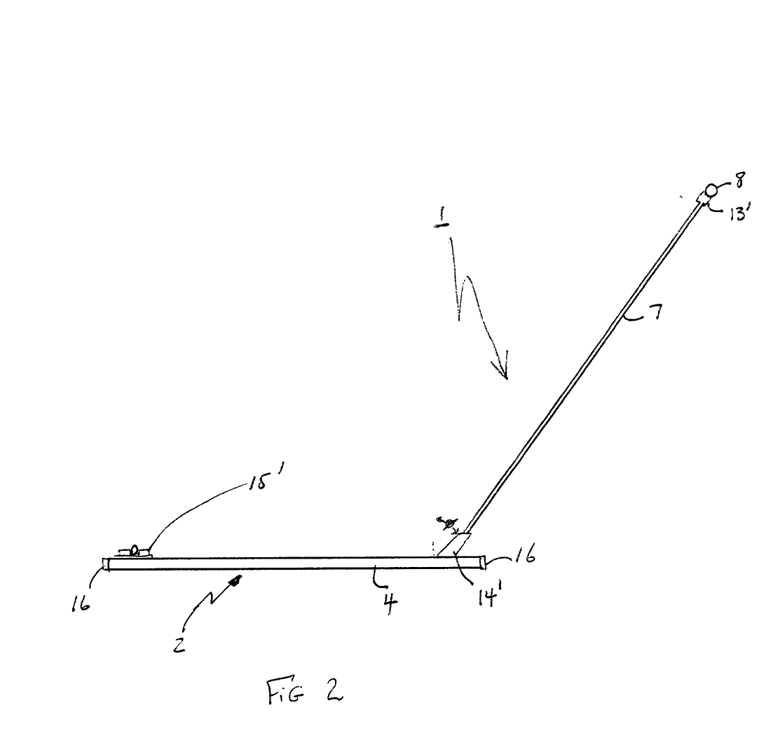

There is further shown two support rods 6 and 7, and an upper holder rod 8, a lower holder rod 9, connectors 11 and 11′ for the upper rod 8. The connectors 11 and 11′ are unitary structures comprised of two components, namely, connector components 12 and 12′, and the tubes 13 and 13′, wherein each of the connector components 12 and 12′ and each of the tubes 13 and 13′, respectively, are an integral unit to form the connectors 11 and 11′. Finally, there is shown the lower support rod connectors 14 and 14′ for holding and stabilizing the support rods 6 and 7. FIG. 2 shows a clearer and full view of the component 14′, the lower support rod connector.

Turning now to FIG. 2, which is a full side view of the display device of FIG. 1, wherein like numbers have like meanings as set forth above, there is further shown lower holder rod connector 15′, which holds the lower holder rod 9 in place while the display device 1 is functioning in the manner intended. Obviously, lower holder rod connector 15 functions in a similar manner to hold the opposite end of the lower holder rod 9.

FIG. 2 also shows the angle θ, the significance of which will be described infra.

Although not required by this invention, there is shown end caps 16 for the side rails 3 and 4. The end caps 16 add to the aesthetic appearance of the display device 1, but are not required for operation of the display device 1.

Now, with reference to FIGS. 3, 4, 5, 6, and 7, and with specificity, there is shown in FIG. 3, a full top view of the base 2 of the invention. There is shown the lower support rod connectors 14 and 14′ and end caps 16.

In addition, there is shown side rail 3 and side rail 4, and 15 and 15′, the lower rod connectors, respectively. The side rails 3 and 4 are connected at their middle zones 10, by the middle connector rail 5. For purposes of connecting the middle connector rail 5, there is shown in phantom, connector inserts 17, which insert into the hollow ends 23 of the middle connector rail 5. The middle connector rail 5 can be easily disassembled from the side rails 3 and 4, by pulling the connector insert 17 (by pulling the respective side rails 3 and 4, from the middle rail 5). It is contemplated within the scope of this invention to use means to solidly connect the middle connector rail 5 and the side rails 3 and 4, such as by using screws, or gluing the components together. This of course, means that disassembly requires an additional step and in the case of the glued parts, no disassembly at all.

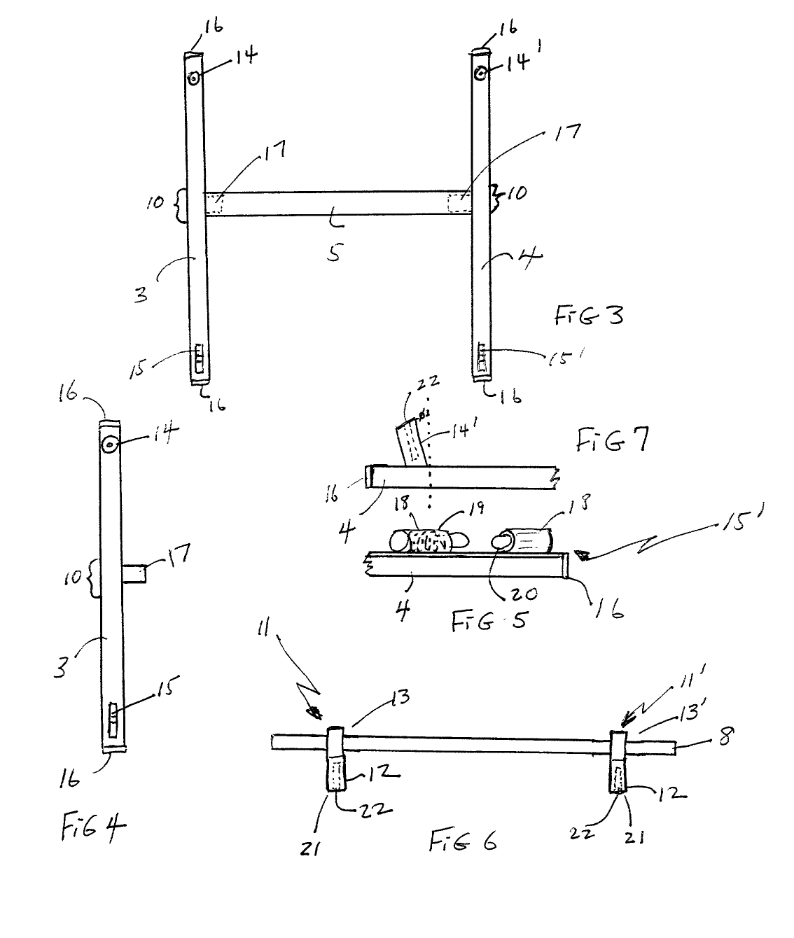

The connector insert 7 can be more easily seen in FIG. 4, which Figure is a top view of side rail 3, again, showing end caps 16, lower support rod connector 14, lower rod connector 15, and middle zone 10.

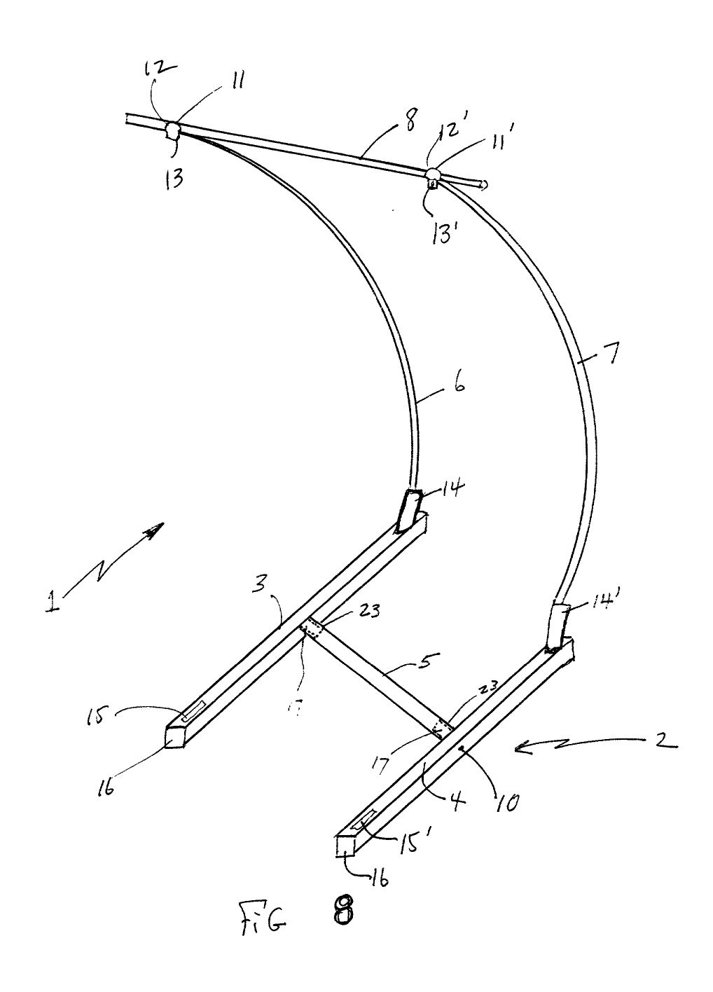

FIG. 5 is an enlarged view of the forward end of the side rail 4, showing the lower rod connector 15′ in detail. It is contemplated within the scope of this invention to use any means for connecting the graphic display banner to the base, but this particular type of connector, known as the graphic latch connector, lends itself well to easy connect and disconnect of the apparatus and is preferred herein. Cabinet door type latches would also work for a connector. This preferred type of connector, i.e. the graphic latch, is comprised of housings 18, for each end of the connector 15′, each such housing 18 containing a spring 19, shown in phantom in FIG. 5, and, a compressible button 20, slidably retained in each housing 18 and forward of the spring 19 in the housing 18. When the lower holder rod 9 is pressed between the buttons 20, the buttons 20 are forced back and the rod 9 inserts to the top surface of the side rail 4, and the buttons 20 are then forced to return to their resting positions by the compressed springs 19, and the buttons retain the rod 9 against the top surface of the side rail 4.

Turning now to FIG. 6, which is a full front view of the upper holder rod 8, and the mechanism 11 and 11′ for connecting the support rods 6 and 7. As indicated supra, the connectors 11 and 11′ for the rod 8 are integral units and are comprised of connector components 12 and 12′, and tube components 13 and 13′. The components 12 and 13 are an integral piece and work together, as well as components 12′ and 13′, in that the tube components 13 and 13′ are configured to spin around the rod 8, such that the ends 21 of such connectors 11 and 11′ can be moved to accommodate the support rod 6 and 7 insertions into retaining wells 22.

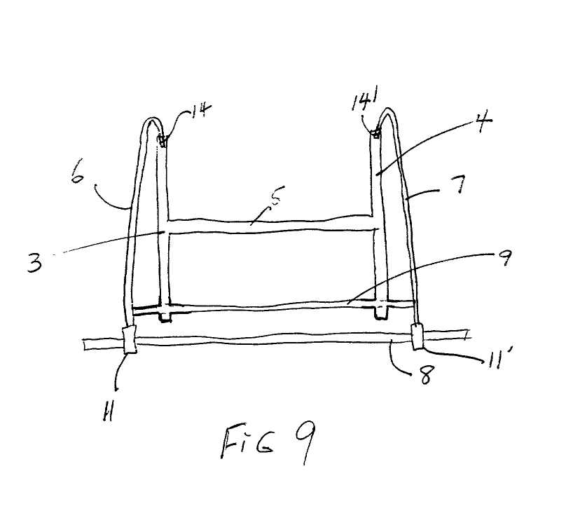

Reference should now be made to FIG. 7, which is the rearward end of the side rail 4, showing the lower support rod connector 14′, it being understood that the side rail 3 and its like components have the same configuration as discussed herein for side rail 4. FIG. 7 therefore shows the side rail 4, the end cap 16, and the lower support rod connector 14′, with the angle theta (0) being shown between the lower support rod connector 14′ and the horizontal configuration of the side rail 4. This angle should be on the order of about 8° to 12′ from the vertical. The device herein cannot adequately function unless the approximate angle of the components 14 and 14′ are maintained, that is, a more vertical angle of the components 14 and 14′ results in a less than desirable effect in the graphics display 25 ultimately displayed on the device 1. It should be obvious to those with ordinary skill in the art and a reading of this specification, and with reference to the Figures, that the tilt of the connectors 14 and 14′ from the vertical is towards the rear of the side rails 3 and 4, and not towards the forward end.

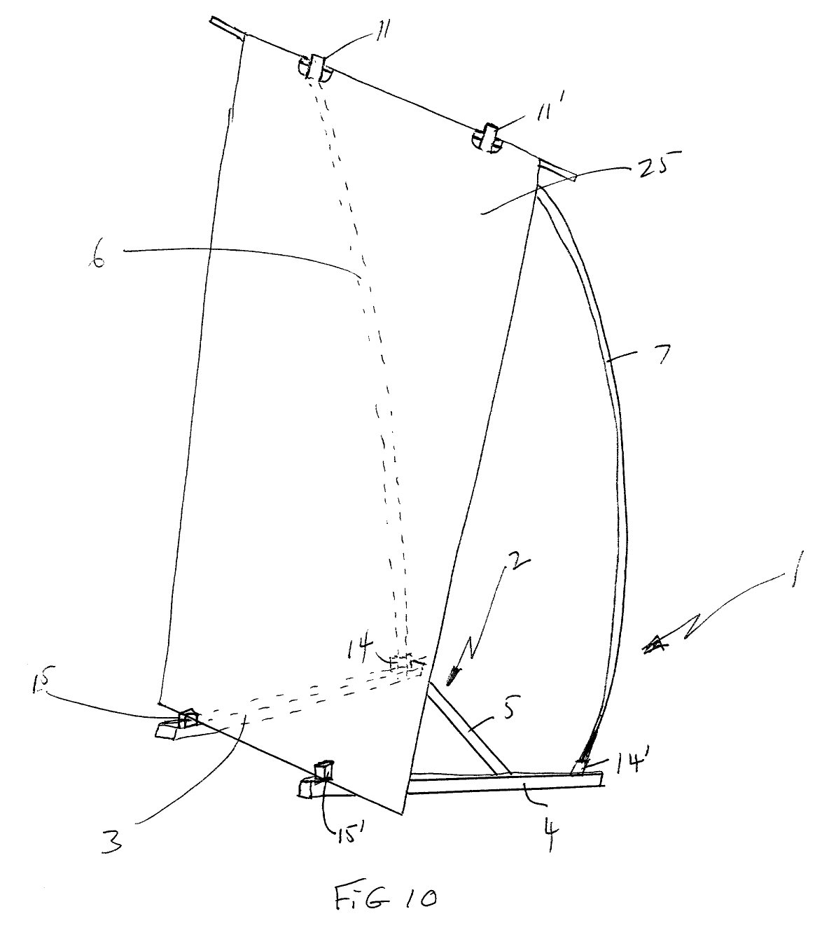

Going forward to FIG. 1, which is a full front view of the device 1 of this invention, but without a graphic display banner 25, there is shown the side rails 3 and 4, the middle connector rail 5, the support rods 6 and 7, the connecting mechanism 11 and 11′, and the upper holder rod 8, to show the configuration of the device 1 without a graphic display banner 25, attached. Note that the support rods 6 and 7 are essentially vertical, having a backward leaning position owing to the angle theta of the lower support rod connectors 14 and 14′, and then, turning to FIG. 8, which is a view in perspective from the front of a device 1 of this invention wherein the configuration of the device 1 is shown as it would appear with a graphic display banner 25 in place, showing the arc of the flexible support rods 6, and 7, it being noted that the graphic display banner 25 is not shown in this Figure, for clarity.

It should be understood by those having ordinary skill in the art that in this configuration, the support rods 6 and 7, by being bent through this arc, provide tension in the graphic display banner 25 and thus, provide a uniform surface to the graphic display banner 25 which lends itself to the overall aesthetics of the device 1 and the display. For purposes of this Figure, like reference numbers have like meanings as set forth supra.

FIG. 9 is a full top view of the device of FIG. 8, wherein the support rods 6 and 7 are under tension, and the graphic display banner 25 is not shown. Therein, like reference numerals have like meanings.

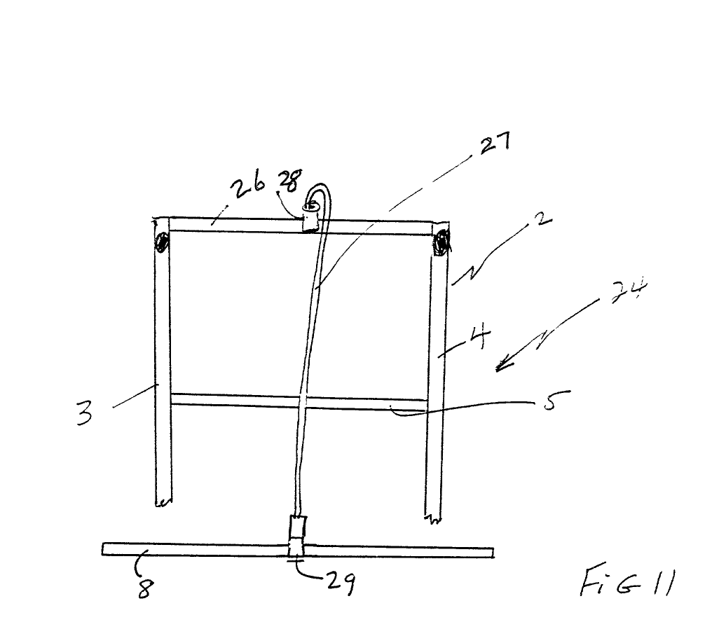

FIG. 10 is a view in perspective of a device 1 of this invention with the graphic display banner 25 in place. Thus, there is shown the device 1, the base 2, wherein the side rail 3, is shown partially in phantom, the support rod 6 and the lower support rod connector 14 are shown in phantom, the upper connectors for the upper holder rod 8, the rod 8 not being shown, and, the middle connector rail 5.

To assemble the device 1 with a display banner 25, one connects the side rails 3 and 4 to the middle connector rail 5 by inserting the connector insert 17, located at the middle zone 10 of each rail, into each of the hollow ends 23 of the middle connector rail 5. Thereafter, the lower ends of the support rods 6 and 7 are inserted into the lower support rod connectors 14 and 14′ . The graphic display banner 25 is then fitted with the upper holder rod 8, and the lower holder rod 9. Thereafter, the upper ends of the support rods 6 and 7 are inserted, respectively, into the connector components 11 and 11′. Finally, the holder rod 9 is pulled down and inserted in the lower rod connectors 15 and 15′ to anchor the graphic display banner 25 and create tension in the support rods 6 and 7, which in turn, provides a smooth, uniform surface on the graphic display banner 25.

The steps provided above are essentially reversed to disassemble the device 1.

There is also contemplated within the scope of this invention, a device 24, similar to device 1, except, there is an additional connector rod 26, which not only connects the back end of the side rails 3 and 4, but also helps stabilize the base 2, and there is only one support rod 27.

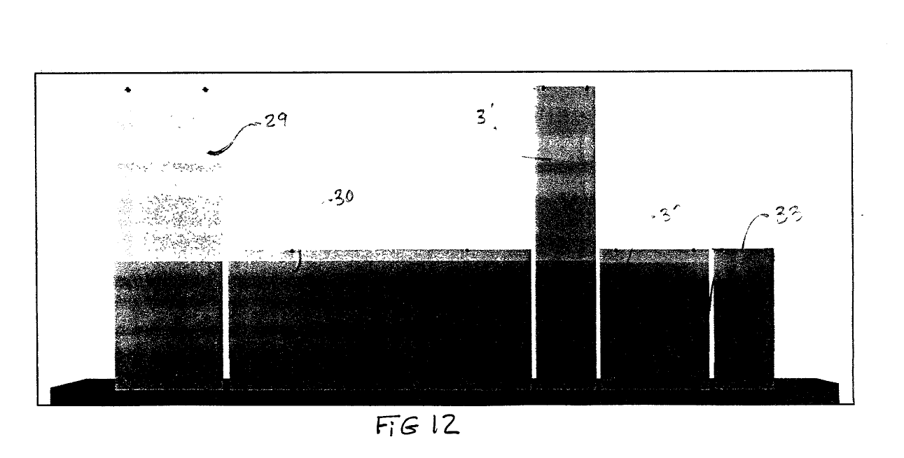

Thus, with regard to FIG. 11, there is shown a display device 24 with one support rod 27, one support rod holder 28, side rails 3 and 4, back connector rail 26, middle connector rail 5, the upper support rod holder 29, and the upper holder bar 8. The connectors for the support rod are configured the same as those of the device 1, and like reference numerals have like meanings as set forth in FIG. 1 and the specification.

Assembly and disassembly of the device 24 is similar to that of device 1.

The systems of this invention encompass the use of one or more of the display devices of this invention in a combination as a backdrop or a display wall for a commercial display. Thus, it is contemplated that a combination could be, for example, as shown in FIG. 12 wherein there is shown displays 29, 30, 31, 32, and 33, having various configurations. It is further contemplated within the scope of this invention to vary the height and width of the devices 1 and 24, in order to vary the display and the display systems.

As shown in FIG. 12, there are two, tall, vertical displays, and three wide, horizontal displays, wherein the devices vary in width and height. Such combinations are fully contemplated within the scope of this invention.

The components of the inventive device are manufactured from metals and/or plastics. For example, the entire apparatus can be manufactured from lightweight metals such as aluminum, or the apparatus can be manufactured from plastics, or the apparatus can be manufactured from a combination of metal and plastics. Preferred for the instant invention is a device manufactured primarily from aluminum metal.

Preferred plastics useful for manufacturing the invention include polypropylene, polyethylene, cross-linked polyethylene, styrene, and fiberglass. Preferred plastics are polypropylene and polyethylene, and most preferred is polypropylene.

The graphics banners useful in this invention include, for example, those manufactured from fabrics, papers, plastics, and it is contemplated within the scope of this invention to provide banners that are made up of one or more than one layer such that special effects can be obtained.

What is claimed is:

1. A display device, said device comprising:
a base,
at least two support rods,
an upper holder rod and,
a lower holder rod,
said based comprised of two parallel and spaced-apart side rails;
each said side rail having a middle zone, a back end, a front end, an inside surface and a top surface, each said side rail having mounted on the top surface, and near the back end, a support rod connector and each side rail having mounted on the top surface and near the front end, a lower holder rod connector;
each said side rail having mounted in the middle zone on the inside surface thereof, a side rail connector for the attachment of a common connector rail for connection to each of the side rails for connecting the two side rails together,
each support rod connector capable of and holding a support rod, each support rod having an upper end, each upper end being connected by an upper holder rod connector to the upper holder rod to support said upper holder rod.

2. A display device as claimed in claim 1 wherein there is additionally attached to the upper holder rod, a banner, and the banner at the end of the banner opposite the upper holder rod, is attached to the lower holder rod and the lower holder rod is connected to the lower holder rod connector.

3. A display device as claimed in claim 1 wherein the support rod connector is mounted such that the top of the support rod connector is tilted towards the back end of the side rail at an angle of about 8° to about 12° from the vertical.

4. A display device as claimed in claim 1 wherein the lower holder rod connector is a graphic latch.

5. A display device as claimed in claim 1 wherein the side and connector rails, the upper holder rod, the lower holder rods, the upper rod connectors, the lower holder rod connectors and the support rods are manufactured from metal.

6. The display device as claimed in claim 5 wherein the metal is aluminum.

7. The display device as claimed in claim 1 wherein the side and connector rails, the upper holder rod, the lower holder rods, the upper rod connectors, the lower holder rod connectors and the support rods are manufactured from plastic.

8. The display device as claimed in claim 7 wherein the plastic is selected from the group consisting essentially of:
polypropylene,
polyethylene,
cross linked polyethylene,
styrene, and,
fiberglass.

9. The display device of claim 2 wherein the banner is a graphic display.

10. The display device of claim 9 wherein the banner is manufactured from fabric.

11. The display device of claim 9 wherein the banner is manufactured from paper.

12. The display device of claim 9 wherein the banner is manufactured from plastic.

13. The display device of claim 10 wherein the banner has more than one layer of fabric.

14. The display device of claim 10 wherein the banner has a backing.

15. A display device, said device comprising:
a base,
a support rod,
an upper holder rod and,
a lower holder rod,
said based comprised of two parallel and spaced-apart side rails;
each said side rail having a middle zone, a back end, a front end, an inside surface and a top surface, each side rail having mounted on the top surface and near the front end, a lower holder rod connector;
each said side rail having mounted in the middle zone on the inside surface thereof, a first side rail connector for the attachment of a first common connector rail for connection to each of the side rails for connecting the two side rails together,
each said side rail having mounted at the respective back ends thereof a second side rail connector for the attachment of a second common connector rail for connection to each of the side rails for connecting the two side rails together, said second common connector rail having a middle zone and a top surface, said second common connector rail having mounted on the top surface, and in the middle zone, a support rod connector; the support rod connector capable of and holding a support rod, the support rod having an upper end, said upper end being connected by an upper holder rod connector to the upper holder rod to support said upper holder rod.

16. A display system comprising a display device as claimed in claim 1 additionally having mounted thereon, a banner.

17. A display system as claimed in claim 16 wherein the banner is a graphic display.

18. A display system as claimed in claim 17 wherein the banner is manufactured from fabric.

19. A display system as claimed in claim 17 wherein the banner is double layered.

20. A display system as claimed in claim 17 wherein the banner has a backing.
